(19) United States
(12) Patent Application Publication
(10) Pub. No.: US 2026/0336178 A1
(43) Pub. Date: Oct. 29, 2026

(54) INJECTION MOLDING CONDITION GENERATION DEVICE, INJECTION MOLDING CONDITION GENERATION METHOD, AND INJECTION MOLDING SYSTEM

(71) Applicant: Hitachi, Ltd., Chiyoda-ku, Tokyo (JP)

(72) Inventors: Daisuke YAGI, Tokyo (JP); Ryotaro SHIMADA, Tokyo (JP); Kan KOBAYASHI, Tokyo (JP)

(21) Appl. No.: 19/114,191

(22) PCT Filed: Aug. 3, 2023
(86) PCT No.: PCT/JP2023/028450

§ 371 Date: Mar. 21, 2025

(30) Foreign Application Priority Data
Nov. 24, 2022 (JP) 2022-187621

(51) Int. Cl. B29C 45/76; B29C 45/78

(52) U.S. Cl. CPC B29C 45/7646; B29C 45/78; B29C 2945/7605; B29C 2945/76531

(57) ABSTRACT

An injection molding condition generation device configured to calculate a characteristic value corresponding to a material based on an in-mold sensor value; to generate a first prediction formula representing a relationship between a viscosity and the characteristic value of the material; to generate a second prediction formula representing a relationship between the characteristic value and the injection molding condition; and to calculate the viscosity corresponding to the first material based on the characteristic value corresponding to a first material and the first prediction formula corresponding to the first material, to calculate the characteristic value corresponding to the second material based on the viscosity corresponding to the first material and the first prediction formula corresponding to a second material, and to generate the injection molding condition suitable for the second material based on the characteristic value corresponding to the second material and the second prediction formula corresponding to the second material.

### TECHNICAL FIELD

The present invention relates to an injection molding condition generation device, an injection molding condition generation method, and an injection molding system. The present invention claims priority to Japanese Patent Application No. 2022-187621 filed on Nov. 24, 2022, and for designated countries where incorporation by reference to documents is permitted, the content described in the application is incorporated herein by reference.

### BACKGROUND ART

In the field of injection molding, it has been promoted to switch materials such as synthetic resins from virgin materials to recycled materials having a low environmental load, in response to a demand for social resource circulation.

The virgin material and the recycled material have different fluidity in a mold. Therefore, when the recycled material after the change is injected into the mold under the same injection molding condition as that suitable for the virgin material before the change, defects such as burrs and short shots may occur in a molded article (product), leading to deterioration of quality. Therefore, when the material for injection molding is changed, it is necessary to adjust the injection molding condition so as to be suitable for the material after the change.

Regarding the adjustment of the injection molding condition, for example, Patent Literature 1 describes an injection molding assisting system 1 including: a process 35 of acquiring a production result using a combination of a mold and a predetermined material and material information on the predetermined material; a process 36 of acquiring the production result, the material information on the predetermined material, and the material information on a plurality of materials acquired in advance, and selecting at least one candidate material from among the plurality of materials based on the acquired information; a process 43 of creating a corrected melding condition for injection molding using a combination of the selected candidate material and mold; and a process 34 of providing a user with the created corrected molding condition and the output candidate material”.

### CITATION LIST

### Patent Literature

Patent Literature 1: JP 2022-66954 A

### SUMMARY OF INVENTION

### Technical Problem

In the case of the technique described in Cited Document 1, the corrected molding condition is defined such that flow characteristics correlated with a viscosity of the material match before and after the change of the material. However, even if the flow characteristics of the materials before and after the change are matched, the viscosities of the materials before and after the change are not necessarily matched. Therefore, there still remains a possibility that the quality of the molded article after the material change is deteriorated.

The present invention has been made in view of the above points, and an object of the present invention is to generate an injection molding condition suitable for a material after a change when the material is changed in injection molding.

### Solution to Problem

The present application includes a plurality of means for solving at least a part of the above problem, and examples thereof are as follows.

In order to solve the above problem, an injection molding condition generation device according to an aspect of the present invention is an injection molding condition generation device for generating an injection molding condition suitable for a second material when a material used for injection molding is changed from a first material to the second material. The injection molding condition generation device includes: a characteristic value calculation unit configured to calculate a characteristic value corresponding to the material, on the basis of an in-mold sensor value in the injection molding; a first prediction formula generation unit configured to generate, for the material each, a first prediction formula representing a relationship between a viscosity and the characteristic value of the material; a second prediction formula generation unit configured to generate, for the material each, a second prediction formula representing a relationship between the characteristic value and the injection molding condition when the material is used; and an injection molding condition generation unit configured to calculate the viscosity corresponding to the first material on the basis of the characteristic value corresponding to the first material and the first prediction formula corresponding to the first material, calculate the characteristic value corresponding to the second material on the basis of the viscosity corresponding to the first material and the first prediction formula corresponding to the second material, and generate the injection molding condition suitable for the second material on the basis of the characteristic value corresponding to the second material and the second prediction formula corresponding to the second material.

### Advantageous Effects of Invention

According to the present invention, at a time of changing a material in injection molding, it is possible to generate an injection molding condition suitable for a material after the change, and it is possible to prevent deterioration in quality of a molded article after the material change.

Problems, configurations, and effects other than those described above will be clarified by the following description of an embodiment.

### BRIEF DESCRIPTION OF DRAWINGS

FIG. 1 is a diagram illustrating an example of an injection molding system according to an embodiment of the present invention.

FIG. 2 is a diagram illustrating a configuration example of a general computing machine.

FIG. 3 is a diagram for describing a characteristic value calculation method for a material.

FIG. 4 is a diagram illustrating an example of a first prediction formula.

FIG. 5 is a diagram illustrating an example of a second prediction formula.

FIG. 6 is a diagram illustrating an example of a material information database (DB).

FIG. 7 is a cross-sectional view illustrating a configuration example of an injection molding machine.

FIGS. 8A to 8B are views illustrating an example of a mold, FIG. 8A is a top view of the mold, FIG. 8B is a side view of the mold, and FIG. 8C is a top view of a runner part of the mold.

FIG. 9 is a flowchart for describing an example of first prediction formula generation processing.

FIG. 10 is a flowchart for describing an example of second prediction formula generation processing.

FIG. 11 is a flowchart for describing an example of injection molding condition generation processing.

FIG. 12 is a flowchart for describing an example of characteristic value calculation processing.

FIG. 13 is a view illustrating display example of a user interface (UI) screen.

### DESCRIPTION OF EMBODIMENTS

An embodiment of the present invention is described below with reference to drawings. The embodiment is an example for describing the present invention, and omission and simplification are appropriately made for clarity of explanation. The present invention can be implemented in various other forms. Unless otherwise specified, each number of components may be one or plural. In order to facilitate understanding of the invention, positions, sizes, shapes, ranges, and the like of the individual components illustrated in the drawings may not represent actual positions, sizes, shapes, ranges, and the like. Therefore, the present invention is not necessarily limited to the positions, sizes, shapes, ranges, and the like disclosed in the drawings. Various types of information as an example may be described with expressions such as “table”, “list”, and “queue”, but the various types of information may be expressed in a data structure other than these. For example, various types of information such as “XX table”, “XX list” , and “XX queue” may be “XX information”. In describing identification information, expressions such as “identification information”, “identifier”, “name”, “ID”, and “number” are used, but these can be replaced with each other. In all the drawings for describing the embodiment, the same members are denoted by the same reference numerals in principle, and repeated description thereof will be omitted. In addition, in the following embodiment, components (including element steps and the like) are not necessarily essential unless otherwise specified or considered to be obviously essential in principle. In addition, when the terms “made of A”, “constituted by A”, “having A”, and “including A” are used, other elements are not excluded unless it is specifically stated that only the element is included. Similarly, in the following embodiment, when the shapes, positional relationships, and the like of the components and the like are referred to, the shapes and the like substantially approximate or similar to the shapes and the like are included unless otherwise specified or unless obviously considered in principle.

### Configuration Example of Injection Molding System 10 According to Embodiment of Present Invention

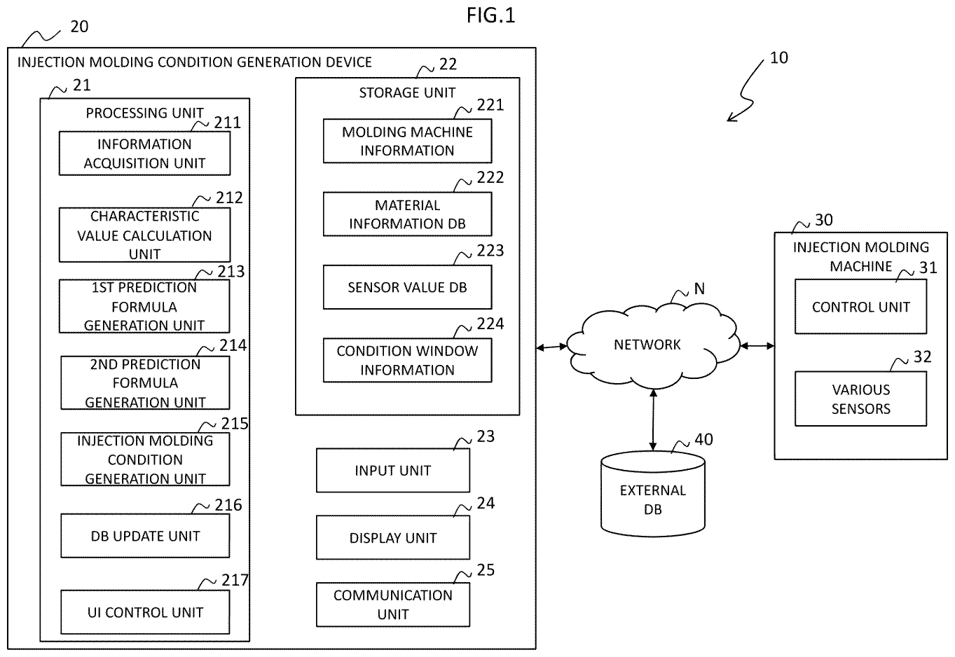

FIG. 1 illustrates a configuration example of an injection molding system 10 according to an embodiment of the present invention. The injection molding system 10 includes an injection molding condition generation device 20, an injection molding machine 30, and an external DB 40.

The injection molding condition generation device 20 generates an injection molding condition suitable for a second material when a material (synthetic resin such as polypropylene) is changed from a first material to the second material, in injection molding using the same mold.

Here, for example, the first material is a virgin. material including a novel raw material, and the second material is a recycled material using a plastic product or the like as a raw material. However, the first material and the second material are not limited to the examples described above. For example, the first material and the second material may be virgin materials having different raw materials. For example, the first material and the second material may be recycled materials having different raw materials.

The injection molding condition generation device 20 includes functional blocks of a processing unit 21, a storage unit 22, an input unit 23, a display unit 24, and a communication unit 25. The injection molding condition generation device 20 includes a general computing machine such as a personal computer of a server computer.

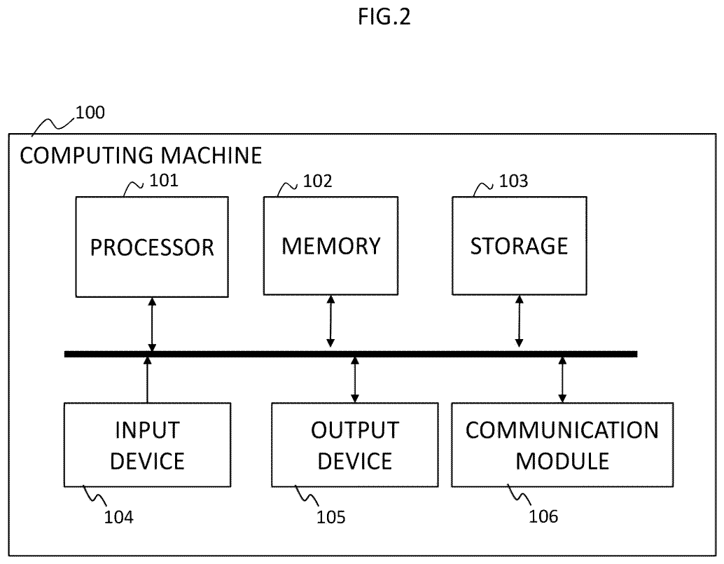

FIG. 2 illustrates a configuration example of a general computing machine 100. The computing machine 100 includes a processor 101 such as a central processing unit (CPU) or a graphics processing unit (GPU), a memory 102 such as a dynamic random access memory (DRAM), a storage 103 such as a hard disk drive (HDD) or a solid state drive (SSD), an input device 104 such as a keyboard, a mouse, or a touch panel, an output device 105 such as a display, and a communication module 106 such as a network interface card (NIC).

The computing machine 100 executes a program with the processor 101, and performs processing defined by the program by using storage resources (the memory 102 and the storage 103), the communication module 106, and the like. Therefore, the subject of the processing performed by executing the program may be the processor 101. Similarly, the subject of the processing performed by executing the program may be a controller, a device, a system, a computing machine, or a node having a processor. The subject of the processing performed by executing the program is only required to be an arithmetic unit, and may include a dedicated circuit that performs specific processing Here, the dedicated circuit is, for example, a field programmable gate array (FPGA), an application specific integrated circuit (ASIC), a complex programmable logic device (CPLD), and the like.

The program may be installed in the computing machine 100 from a program source. The program source may be, for example, a program distribution server or a storage medium readable by the computing machine 100. When the program Source is a program distribution server, the program distribution server may include a processor and a storage resource that stores a distribution target program, and the processor of the program distribution server may distribute the distribution target program to another computing machine. In the embodiment, two or more programs may be implemented as one program, or one program may be implemented as two or more programs.

The processing unit 21 is implemented by the processor 101 included in the computing machine 100. The processing unit 21 includes functional blocks of an information acquisition unit 211, a characteristic value calculation unit 212, a first prediction formula generation unit 213, a second prediction formula generation unit 214, an injection molding condition generation unit 215, a DB update unit 216, and a UI control unit 217. Those functional blocks are implemented by the processor 101 executing a predetermined program loaded in a memory. However, some or all of these functional blocks may be implemented as hardware by an integrated circuit or the like. In addition, these functional blocks may be implemented by one computing machine 100 or may be implemented by a plurality of computing machines 100. In the case where the functional blocks are implemented by a plurality of computing machines 100, the plurality of computing machines 100 only need to be connected via a network N, and may be distributed and arranged at remote locations.

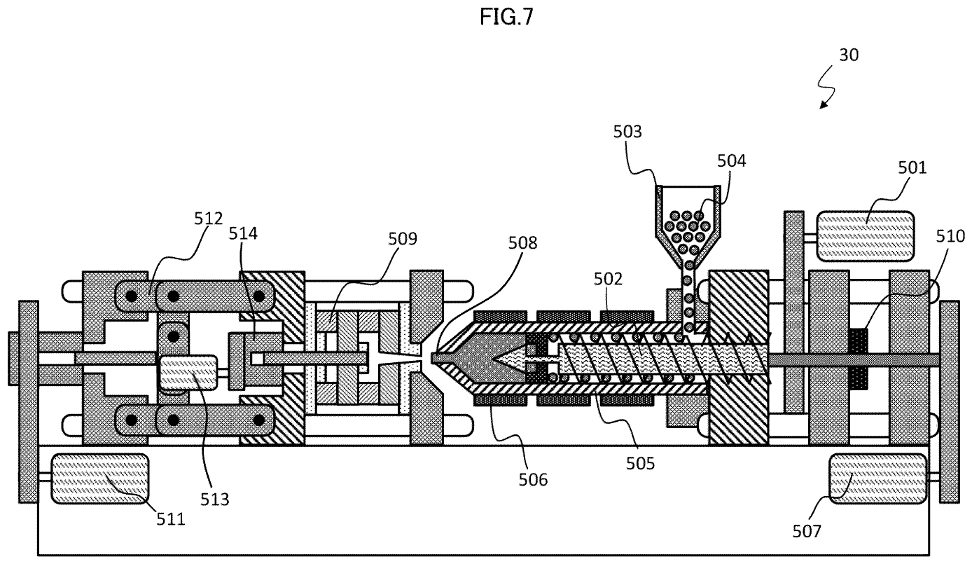

The information acquisition unit 211 acquires various types of information from the injection molding machine 30 connected via the network N, and stores the information in the storage unit 22. For example, the information acquisition unit 211 acquires, from the injection molding machine 30, time-series data of various sensor values (including a material pressure) in a mold in injection molding processing executed a plurality of times while a temperature of each material is changed, and the information acquisition unit 211 stores the time-series data in the storage unit 22 as a sensor value DB 223 (to be described in detail later). Here, the temperature may be a temperature of a material in the mold, or may be a parameter (for example, a set value of a heater 506 (FIG. 7) for heating a material) for controlling the temperature of the material.

The characteristic value calculation unit 212 refers to the sensor value DB 223 in the storage unit 22, and calculates a characteristic value correlated with a viscosity for each material. In general, it is known that a viscosity of a synthetic resin as a material is correlated with a pressure in the mold. Therefore, the characteristic value calculation unit 212 calculates the characteristic value on the basis of a pressure sensor value in the mold. As a result, the characteristic values calculation unit 212 can obtain the characteristic value correlated with the viscosity of the material in the mold. Then, the characteristic value calculation unit 212 records the temperature and the characteristic value in a material information DB 222 in the storage unit 22 in association with each material.

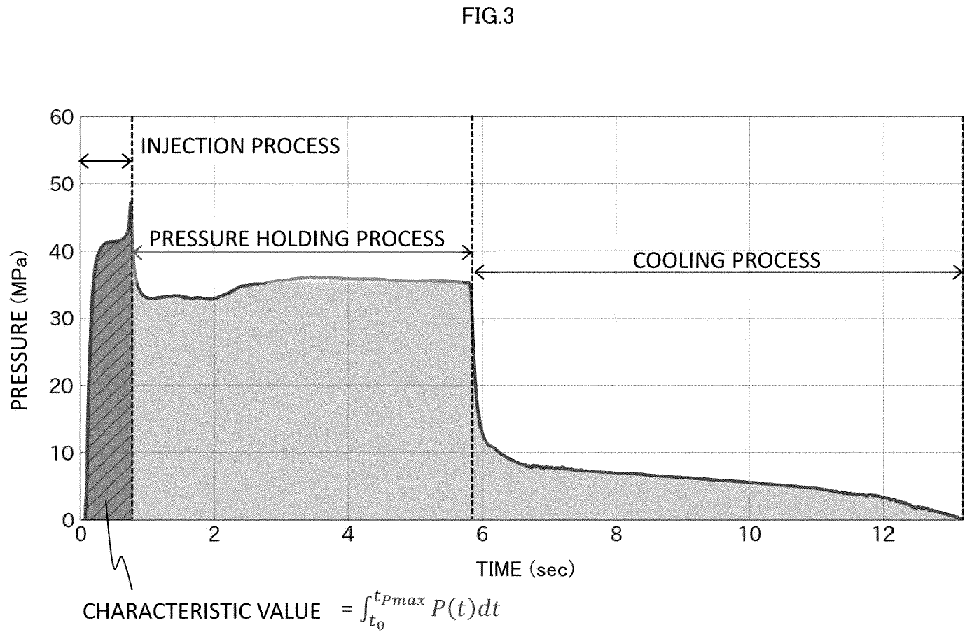

FIG. 3 is a diagram for describing a characteristic value calculation method by the characteristic value calculation unit 212. FIG. 3 illustrates a time-series change in an in-mold sensor pressure value (material pressure) of a material when injection molding processing is performed at a predetermined temperature.

A series of injection molding processing is roughly divided into a measuring/plasticizing process (not illustrated) of measuring and plasticizing a material, an injection process of filling a mold with a material, a pressure holding process of maintaining a constant pressure on the material, a cooling process of cooling and solidifying the material, and an extraction process (not illustrated) of extracting a formed product from the mold.

The characteristic value calculation unit 212 refers to the sensor value DB 223 and calculates, as a characteristic value of a material, an integral value (an area of a shaded portion in the figure) of a material pressure in the injection process (from an injection start timing t0 to a timing t_{Pmax} at which the material pressure reaches a maximum value). As a result, the characteristic value calculation unit 212 can acquire a characteristic value based on a calculation formula having physical support. Note that, instead of calculating the integral value of the material pressure in the injection process as the characteristic value, for example, a maximum value of the material pressure may be detected, or dispersion of the material pressure in the injection process may be calculated. The characteristic value calculation unit 212 records the calculated characteristic value in the material information DB 222 stored in the storage unit 22, in association with the material and a temperature thereof.

Returning to FIG. 1. The first prediction formula generation unit 213 refers to the material information DB 222 stored in the storage unit 22, and generates a first prediction formula representing a relationship between a characteristic value and a viscosity for each material, on the basis of a plurality of pieces of combination data of a characteristic value and a viscosity at different temperatures. Specifically, the first prediction formula generation unit 213 generates the first prediction formula by, for example, fitting to a known function such as a linear function using a least squares method, machine learning, or the like. The first prediction formula generation unit 213 records the first prediction formula generated for each material, in the material information DB 222 in the storage unit 22.

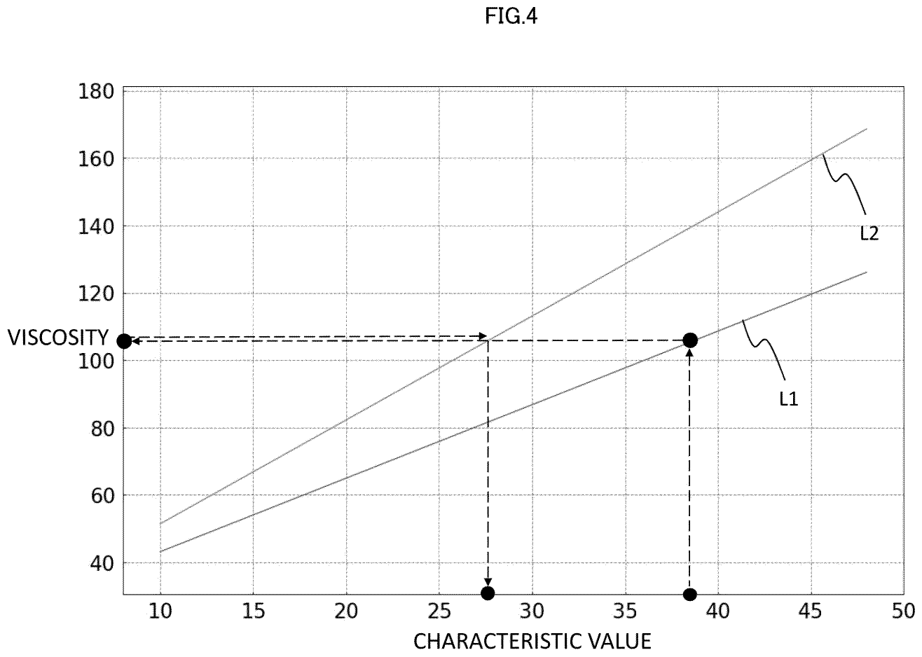

FIG. 4 illustrates an example of a first prediction formula L1 corresponding to a first material and a first prediction formula L2 corresponding to a second material. For example, in a case of the figure, a viscosity corresponding to a characteristic value of the first material can be estimated using the first prediction formula L1. In addition, a characteristic value of the second material in a case of having the same viscosity as the viscosity of the first material can be estimated using the first prediction formula L2.

Returning to FIG. 1. The second prediction formula generation unit 214 refers to the material information DB 222 stored in the storage unit 22, and generates, for each material, a second prediction formula that satisfies a relationship between an injection molding condition and a characteristic value, by using machine learning or the like. The second prediction formula generation unit 214 records the second prediction formula generated for each material, in the material information DB 222 in the storage unit 22.

Note that the injection molding condition includes at least a temperature. Here, the temperature may be a temperature of the material or a parameter for controlling the temperature of the material. When only the temperature is set as the injection molding condition, the following existing Andrade equation representing a relationship between a temperature and a viscosity can be adopted as the second prediction formula. Since the Andrade equation is an equation according to an existing physical model, an injection molding condition (temperature) with high accuracy in controlling a viscosity of a material can be obtained. In that case, the second prediction formula generation unit 214 only needs to specify coefficients a and b unique to the material.
Viscosity of material=a·exp (b/temperature)

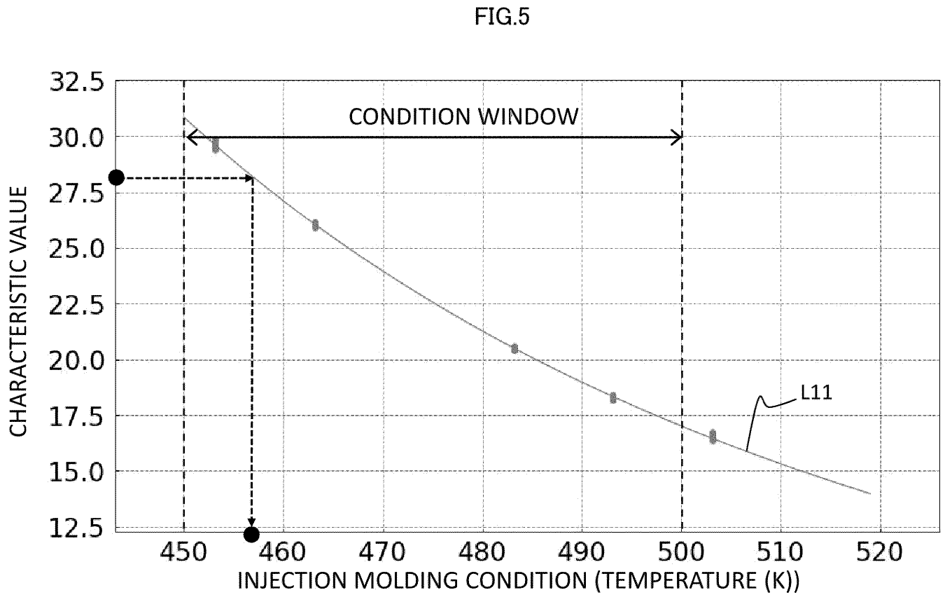

FIG. 5 illustrates an example of a second prediction formula 111 corresponding to the second material in a case where only a temperature is set as the injection molding condition and the Andrade equation is adopted as the second prediction formula. According to the second prediction formula, an injection molding condition (temperature) Corresponding to a characteristic value of the second material can be estimated. Note that, a condition window in the figure indicates a lower limit and an upper limit of the injection molding condition (temperature) for each material.

Returning to FIG. 1. The injection molding condition generation unit 215 generates an injection molding condition suitable for the second material, on the basis of a characteristic value corresponding to an injection molding condition at a time of mass production using a first material before a change, a first prediction formula corresponding to the first material, a first prediction formula corresponding to a second material after the change, and a second prediction formula corresponding to the second material.

The DB update unit 216 refers to the external database 40, acquires a material temperature and a viscosity of the material that are not recorded in the material information DB 222 in the storage unit 22, and updates the material information DB 222.

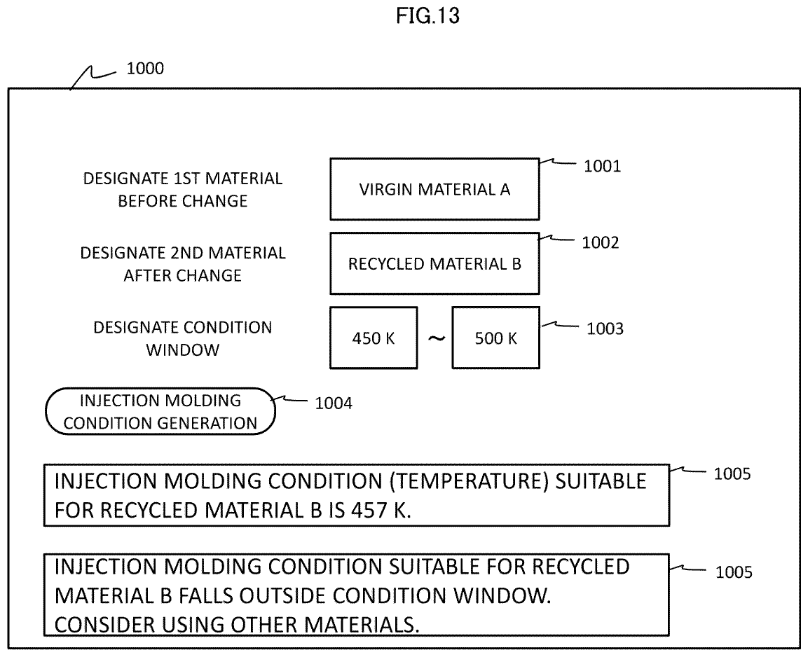

The UI control unit 217 causes the display unit 24 to display a UI screen 1000 (FIG. 13). In addition, the UI control unit 217 displays, on the UI screen 1000, an injection molding condition that is generated by the injection molding condition generation unit 215 and is suitable for the second material. Furthermore, in a case where the injection molding condition suitable for the second material is out of a range of a condition window set in advance by the user, the UI control unit 217 proposes a change of the second material to the user on the UI screen 1000.

The storage unit 22 is implemented by a storage included in a computer. The storage unit 22 records molding machine information 221, the material information DB 222, the sensor value DB 223, and condition window information 224.

The molding machine information 221 records injection. molding conditions and mold information (for example, a model number, specifications, and the like of the mold) acquired by the information acquisition unit 211 from the injection molding machine 30.

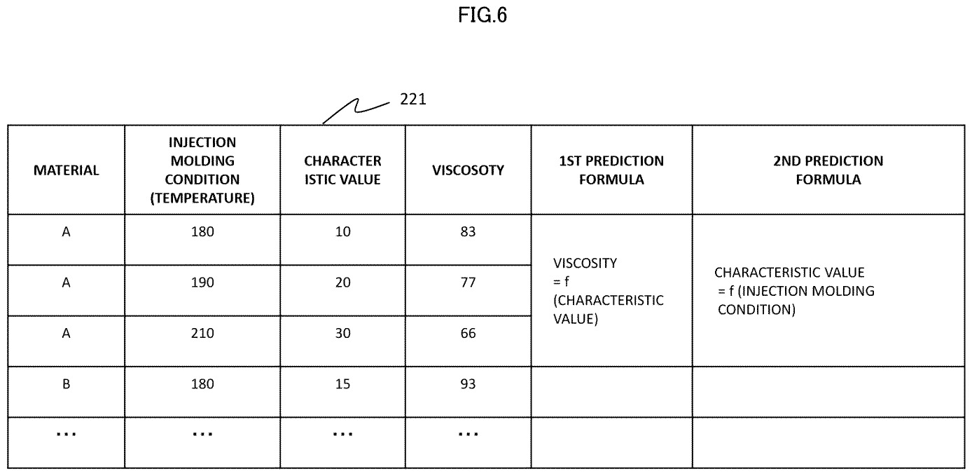

FIG. 6 illustrates an example of the material information DB 222. In the material information DB 222, an injection molding condition (temperature), a characteristic value, a viscosity, a first prediction formula, and a second prediction formula are recorded in association with each material.

For the injection molding condition (temperature) and the viscosity in the material information DB 222, it is assumed that values corresponding to the individual materials are recorded in advance. However, when necessary information (an injection molding condition (temperature) and a viscosity for a certain material) is insufficient, the information acquisition unit 211 can acquire the information by referring to the external DB 40, and the DB update unit 216 can update the material information DB 222 by adding the acquired information. Since the external DB 40 can be referred to, for example, it is possible to save time and effort for a user to actually measure the viscosity of the material.

As the characteristic value in the material information DB 222, a value calculated by the characteristic value calculation unit 212 is recorded. As the first prediction formula, a formula generated by the first prediction formula generation unit 213 is recorded. As the second prediction formula, a formula generated by the second prediction formula generation unit 214 is recorded.

Returning to FIG. 1. The sensor value DB 223 records, for each material, time-series data of measurement values (including a material pressure measured by a pressure sensor) by a sensor 32 in the mold in the injection molding processing executed a plurality of times while the temperature is changed. Note that information (for example, a flag) indicating that the time-series data corresponds to the time of mass production is added to the time-series data corresponding to the time of mass production, among the plurality of pieces of time-series data having different temperatures for each material.

The condition window information 224 records a condition window set for each material, that is, a lower limit value and an upper limit value of the injection molding condition. As the condition window information 224, a lower limit value and an upper limit value of the injection molding condition designated by a material manufacturer or the like for each material may be recorded in advance, or may be set by the user.

The input unit 23 is implemented by an input device included in the computer. The input unit 23 receives various inputs from the user. The display unit 24 is implemented by a liquid crystal display or the like included in the computer. The display unit 24 displays the UI screen 1000 under the control of the UI control unit 217. The communication unit 25 is implemented by a communication module included in the computer. The communication unit 25 connects the injection molding machine 30 and the external DB 40 via the network N, and transmits and receives various types of information.

Note that, when the injection molding condition generation device 20 is present on a cloud server, for example, the user connects to the injection molding condition generation device 20 via the network N through a terminal device such as a PC used by the user, and the user. operates the injection molding condition generation device 20.

The network N is a bidirectional communication network represented by the Internet.

The injection molding machine 30 manufactures a molded article by injecting a material into a mold, holding a pressure, and cooling the material. The injection molding machine 30 includes a control unit 31 that integrally controls each part of the injection molding machine 30, and one or more sensors 32 provided in the mold. The sensor 32 includes at least a pressure sensor that measures a material pressure in the mold, and may also include a material temperature sensor and a mold temperature sensor. The injection molding machine 30 outputs the injection molding condition including a sensor value measured by the sensor 32 to the injection molding condition generation device 20, in response to a request from the information acquisition unit 211 of the injection molding condition generation device 20.

The injection molding condition includes at least a temperature (a temperature of the material or a parameter for controlling the temperature of the material). In addition, the injection molding condition may include a mold temperature, a pressure holding value, a pressure holding time, a cooling time, and the like.

### Operation of Injection Molding Machine 30

Next, an operation at a time of injection molding processing by the injection molding machine 30 will be described. FIG. 7 is a cross-sectional view illustrating a configuration example of the injection molding machine 30.

As described above, the series of injection molding processing is roughly divided into the measuring/plasticizing process, the injection process, the pressure holding process, the cooling process, and the extraction process.

In the measuring/plasticizing process, the injection molding machine 30 retracts a screw 502 with a plasticizing motor 501 as a driving force, and supplies a resin pellet 504 as a material from a hopper 503 into a cylinder 505. Then, the material is plasticized and brought into a uniform molten state by heating the cylinder 505 with the heater 506 and rotating the screw 502.

In the injection process and the pressure holding process, the injection molding machine 30 advances the screw 502 with an injection motor 507 as a driving force, and injects the molten material into a mold 509 through a nozzle 508. At this time, a pressure measured by a load cell 510 is controlled to approach a pressure holding value included in the injection molding condition. Cooling from a wall surface of the mold 509 and shear heat generated by a flow act in parallel on the molten material injected into the mold 509. That is, the molten material flows in the mold 509 while being subjected to the cooling action and the heating action.

In the cooling process, the injection molding machine 30 cools the mold 509 to a solidification temperature or lower, to solidify the molten material.

In the extraction process, the injection molding machine 30 drives a mold clamping mechanism 512 with a motor 511 as a driving force, to release the mold 509. Then, an ejector mechanism 514 is driven with a pushing motor 513 as a driving force to extract a molded article in which the molten material is solidified, from the mold 509.

In each process of the injection molding processing, various parameters are set as injection molding conditions for the injection molding machine 30. For example, in the measuring/plasticizing process, a measurement position, suck back, a back pressure, a back pressure speed, a rotation speed, and the like are set. In the injection process and the pressure holding process, a pressure holding value, a temperature, a shear rate, a pressure holding time, a screw position (VP switching position) for switching between injection and pressure, a clamping force of the mold 509, and the like of the material are set. For the cooling process, a temperature and a cooling time after pressure holding are set. Note that a temperature parameter may be a set temperature of the heater 506, a temperature and a flow rate of a refrigerant for cooling the mold 509, or the like.

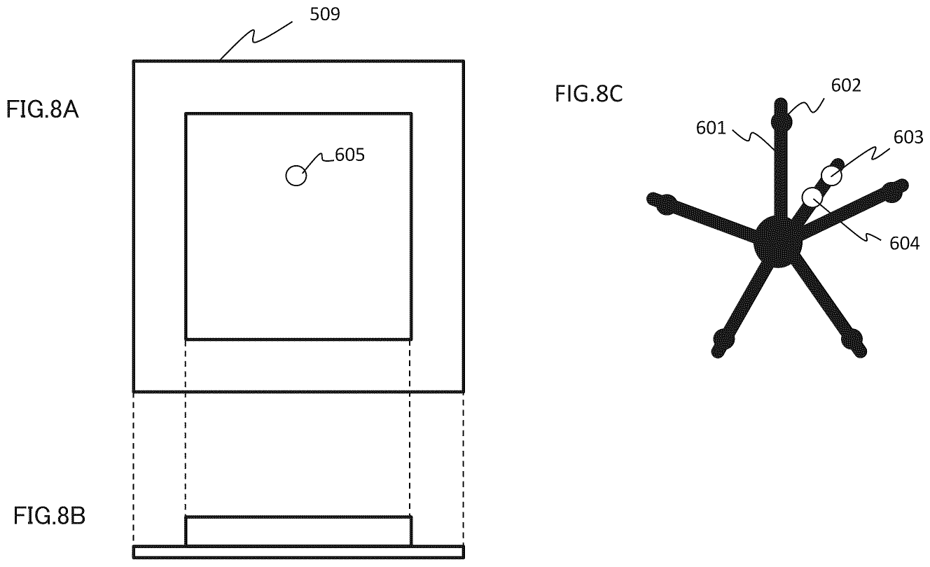

Next, FIGS. 8A to 8C illustrate an example of the mold 509. FIG. 8A illustrates a top view of the mold 509, FIG. 8B illustrates a side view of the mold 509, and FIG. 8C illustrates a top view of a runner part 601 of the mold 509.

The mold 509 has five runner parts 601, and the molten material flows into the mold 509 from pin gates 602 provided in the individual runner parts 601. The mold 509 includes a pressure sensor 603 that measures a pressure of the material in the mold 509, a temperature sensor 604 that measures a temperature of the material, and a temperature sensor 605 that measures a temperature of the mold 509. The pressure sensor 603 and the temperature sensors 604 and 605 correspond to the sensor 32 (FIG. 1).

### First Prediction Formula Generation Processing by Injection Molding Condition Generation Device 20

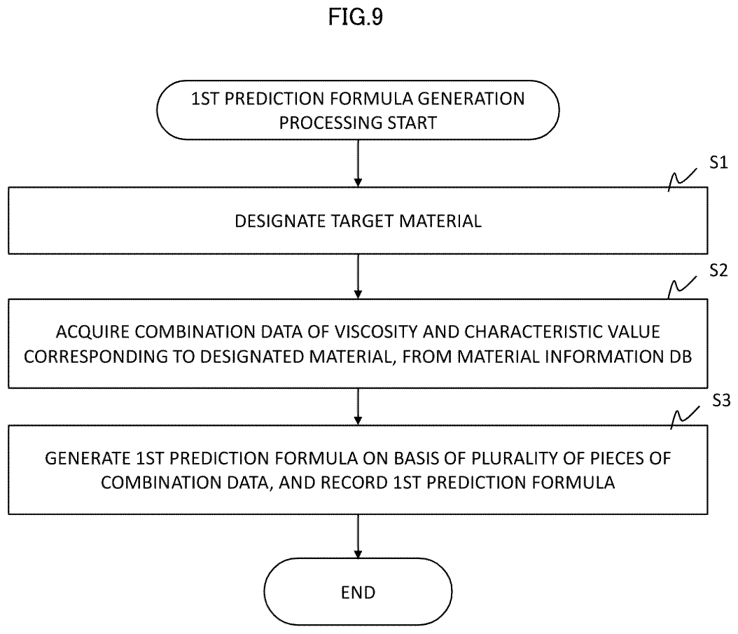

Next, FIG. 9 is a flowchart for describing an example of first prediction formula generation processing by the injection molding condition generation device 20. The first prediction formula generation processing is executed in advance prior to injection molding condition generation processing to be described later.

First, the input unit 23 receives designation from the user on a material for which a first prediction formula is generated (step S1). Next, the first prediction formula generation unit 213 acquires combination data of a viscosity and a characteristic value at a plurality of different temperatures corresponding to the material designated by the user, from the material information DB 222 in the storage unit 22 (step S2).

Note that, when the combination data does not exist in the material information DB 222 or the number of pieces thereof is insufficient, the information acquisition unit 211 acquires a viscosity of the material at a predetermined material temperature from the external DB 40, and the DB update unit 216 updates the material information DB 222. In addition, the characteristic value calculation unit 212 refers to the sensor value DB 223 to calculate a characteristic value of the material at the predetermined material temperature, and the DB update unit 216 updates the material information DB 222. Then, the first prediction formula generation unit 213 may simply acquire the combination data from the material information DB 222 again.

Next, the first prediction formula generation unit 213 generates the first prediction formula on the basis of a plurality of pieces of combination data of a characteristic value and a viscosity at different temperatures acquired from the material information DB 222, and records the first prediction formula in the material information DB 222 in the storage unit 22 (step S3). The first prediction formula generation processing by the injection molding condition generation device 20 is thus terminated.

### Second Prediction Formula Generation Processing by Injection Molding Condition Generation Device 20

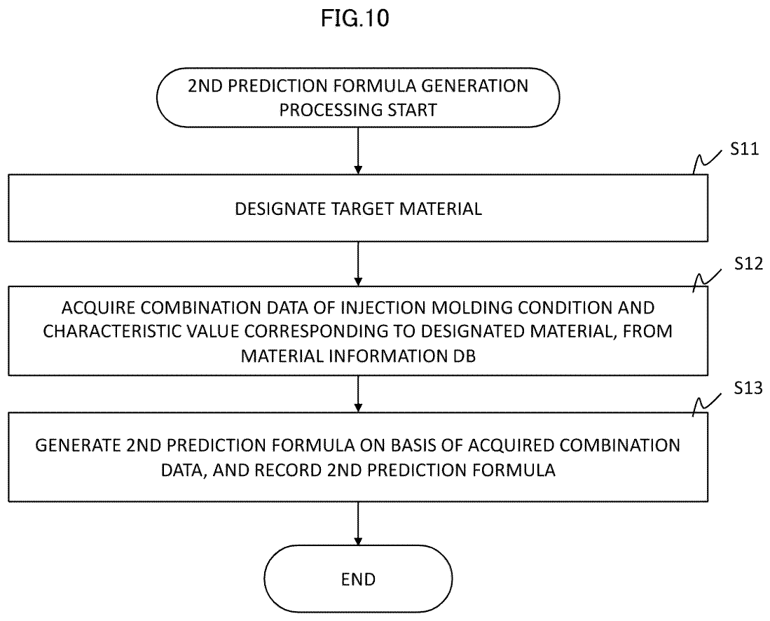

Next, FIG. 10 is a flowchart for describing an example of second prediction formula generation processing by the injection molding condition generation device 20. Similar to the first prediction formula generation processing described above, the second prediction formula generation processing is executed in advance prior to the injection molding condition generation processing described later.

First, the input unit 23 receives designation from the user on a material for which a second prediction formula is generated (step S11). Note that, when the second prediction formula generation processing is executed following the first prediction formula generation processing described above, the specification result in step S1 may be held, and step S11 may be omitted.

Next, the second prediction formula generation unit 214 acquires a plurality of pieces of combination data of injection molding information (material temperature) and a characteristic value corresponding to the material designated by the user, from the material information DB 222 in the storage unit 22 (step S12).

Note that, when the combination data does not exist in the material information DB 222 or the number of pieces thereof is insufficient, the characteristic value calculation unit 212 refers to the sensor value DB 223 to calculate a characteristic value at a predetermined temperature corresponding to the material, and the DB update unit 216 updates the material information DB 222. Then, the second prediction formula generation unit 214 may simply acquire the combination data from the material information DB 222 again.

Next, the second prediction formula generation unit 214 generates the second prediction formula on the basis of combination data of the injection molding information (material temperature) and the characteristic value at a plurality of different material temperatures acquired from the material information DB 222, and records the second prediction formula in the material information DB 222 in the storage unit 22 (step S13). The second prediction formula generation processing by the injection molding condition generation device 20 is thus terminated.

### Injection Molding Condition Generation Processing by Injection Molding Condition Generation Device 20

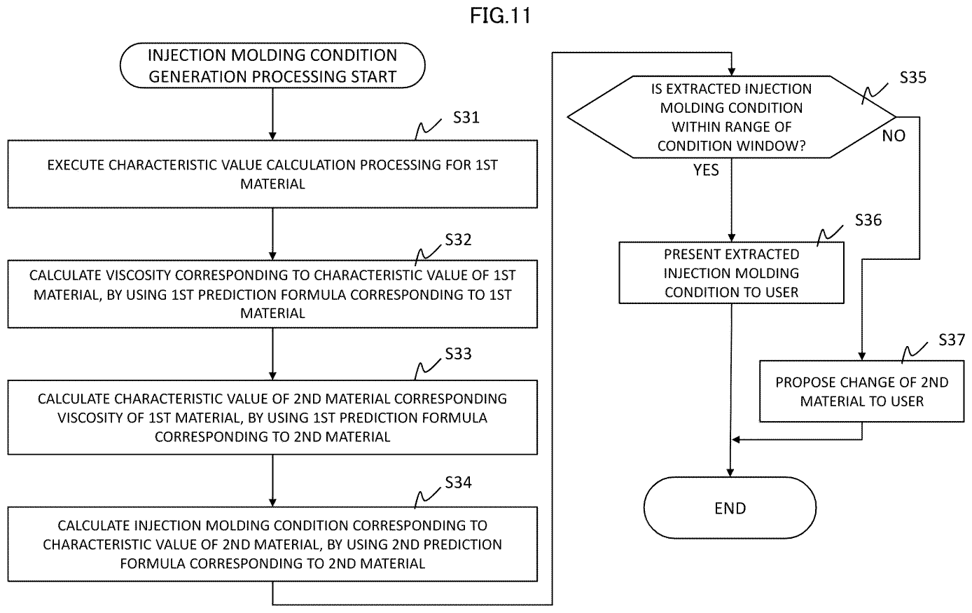

Next, FIG. 11 is a flowchart for describing an example of the injection molding condition generation processing by the injection molding condition generation device 20.

The injection molding condition generation processing is started, for example, when the user operates an “injection molding condition generation” button 1004 after designating the first material before the change and the second material after the change on the UI screen 1000 (FIG. 13) (to be described in detail later).

First, the characteristic value calculation unit 212 executes characteristic value calculation processing for the first material (step S31).

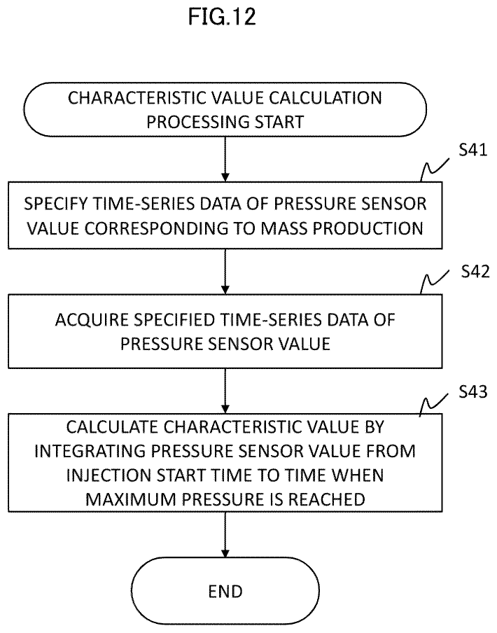

FIG. 12 is a flowchart for describing an example of the characteristic value calculation processing in step S31. First, the characteristic value calculation unit 212 refers to the sensor value DB 223 of the storage unit 22, and specifies time-series data to which a flag indicating that the time-series data corresponds to the time of mass production is added, among the time-series data of the pressure sensor value for the first material (step S41).

Next, the characteristic value calculation unit 212 acquires the specified time-series data from the sensor value DB 223 (step S42). Next, the characteristic value calculation unit 212 calculates a characteristic value of the first material on the basis of the acquired time-series data (step S43).

Returning to FIG. 11. Next, the injection molding condition generation unit 215 acquires a first prediction formula corresponding to the first material from the material information DB 222 in the storage unit 22, and calculates a viscosity corresponding to the characteristic value of the first material calculated in step S31 (step S32). Note that, if the first prediction formula corresponding to the first material does not exist in the material information DB 222, the first prediction formula generation processing described above may simply be executed again to generate the first prediction formula corresponding to the first material.

Next, the injection molding condition generation unit 215 acquires the first prediction formula corresponding to the second material from the material information DB 222 in the storage unit 22, and calculates a characteristic value of the second material corresponding to the same viscosity as the viscosity of the first material calculated in step S32 (step S33). Note that, if the first prediction formula corresponding to the second material does not exist in the material information DB 222, the first prediction formula generation processing described above may simply be executed again to generate the first prediction formula corresponding to the second material.

Next, the injection molding condition generation unit 215 acquires the second prediction formula corresponding to the second material from the material information DB 222 in the storage unit 22, and calculates an injection molding condition corresponding to the characteristic value of the second material calculated in step 333 (step S34). Note that, if the second prediction formula corresponding to the second material does not exist in the material information DB 222, the second prediction formula generation processing described above may simply be executed again to generate the second prediction formula corresponding to the second material.

Next, the UI control unit 217 acquires a lower limit value and an upper limit value of the injection molding condition corresponding to the second material from the condition window information 224 in the storage unit 22, and determines whether or not the injection molding condition corresponding to the second material and generated in step S34 is within a range (the lower limit or more and the upper limit or less) of the condition window (step S35).

Here, when it is determined that the injection molding condition corresponding to the second material is within the range of the condition window (YES in step S35), the UI control unit 217 displays the injection molding condition corresponding to the second material and generated in step S34 on the UI screen 1000, to present the injection molding condition to the user (step S36).

Conversely, when it is determined that the injection molding condition corresponding to the second material is not within the range of the condition window (NO in step S35), the UI control unit 217 proposes a change of the second material on the UI screen 1000 since the material specified by the user as the second material after the change is not suitable (step S37). The injection molding condition generation processing by the injection molding condition generation device 20 is thus terminated.

### Display Example of UI Screen 1000

Next, FIG. 13 illustrates a display example of the UI screen 1000. The UI screen 1000 is provided with an input field 1001 for designating the first material before the change, an input field 1002 for designating the second material after the change, an input field 1003 for designating the condition window, the “injection molding condition generation” button 1004 for instructing generation of an injection molding condition suitable for the second material, and a display field 1005 for displaying the generated injection molding condition suitable for the second material.

For example, a product number, a lot number, and the like of the material can be input to the input fields 1001 and 1002. For example, a lower limit value and an upper limit value of a temperature as the injection molding condition can be input to the input field 1003.

In the display field 1005, for example, “the injection molding condition (temperature) suitable for Recycled material B is 457 K” or the like is displayed as the generated injection molding condition suitable for the second material. However, in a case where the generated injection molding condition suitable for the second material is out of the range of the condition window, for example, a message for prompting to change the second material is displayed, such as “The injection molding condition suitable for the recycled material B falls outside the condition window. Consider using other materials”.

According to the injection molding condition generation processing described above, it is possible to generate an injection molding condition corresponding to the second material, in which a viscosity of the first material at the time of mass producing molded articles using the first material before the material change can be matched with a viscosity of the second material after the material change. Therefore, when injection molding is performed using the second material under the generated injection molding condition, it is possible to prevent deterioration in quality of the molded article after the material change regardless of the skill of the user. In addition, in a case where the second material designated by the user is not suitable for the material after the change, the change of the material can be prompted.

Note that, as a modification, instead of presenting the injection molding condition corresponding to the second material to the user in step S36, the injection molding condition corresponding to the second material may be output from the injection molding condition generation device 20 to the injection molding machine 30 via the network N, to perform the injection molding processing.

The present invention is not limited to the above-described embodiment, and various modifications are possible. For example, the embodiment described above has been illustrated in detail to facilitate description for easy understanding of the present invention, and is not necessarily limited to the embodiment that includes all the configurations. In addition, a part of the configuration of one embodiment can be replaced with or added to the configuration of another embodiment.

Furthermore, part of all of the above-described configurations, functions, processing units, processing means, and the like may be implemented by hardware by being designed as an integrated circuit, for example. Alternatively, the above configurations, functions, and the like may be implemented by software by a processor interpreting and executing a program that implements each function. Information such as programs, tables, and files for implementing individual functions can be stored in a recording device such as a memory, a hard disk, and an SSD, or in a recording medium such as an IC card, an SD card, and a DVD. Further, control lines and information lines indicate what is considered to be necessary for the description, and do not necessarily indicate all the control lines and the information lines on the product. In practice, it can be considered that almost all the structures are mutually connected.

### REFERENCE SIGNS LIST

10 Injection molding system
20 Injection molding condition generation device
21 Processing unit
211 Information acquisition unit
212 Characteristic value calculation unit
213 First prediction formula generation unit
214 Second prediction formula generation unit
215 Injection molding condition generation unit
216 DB update unit
217 UI control unit
22 Storage unit
221 Molding machine information
222 Material information DB
223 Sensor value DB
224 Condition window information
23 Input unit
24 Display unit
25 Communication unit
100 Computing machine
30 Injection molding machine
31 Control unit
32 Sensor
40 External database
1000 UI screen

1. An injection molding condition generation device for generating an injection molding condition suitable for a second material when a material used for injection molding is changed from a first material to the second material,
the injection molding condition generation device comprising:
a characteristic value calculation unit configured to calculate a characteristic value corresponding to the material on a basis of an in-mold sensor value in the injection molding;
a first prediction formula generation unit configured to generate, for the material each, a first prediction formula representing a relationship between a viscosity and the characteristic value of the material;
a second prediction formula generation unit configured to generate, for the material each, a second prediction formula representing a relationship between the characteristic value and the injection molding condition when the material is used; and
an injection molding condition generation unit configured to calculate the viscosity corresponding to the first material on a basis of the characteristic value corresponding to the first material and the first prediction formula corresponding to the first material, calculate the characteristic value corresponding to the second material on a basis of the viscosity corresponding to the first material and the first prediction formula corresponding to the second material, and generate the injection molding condition suitable for the second material on a basis of the characteristic value corresponding to the second material and the second prediction formula corresponding to the second material.

2. The injection molding condition generation device according to claim 1, wherein
the characteristic value calculation unit calculates the characteristic value on a basis of an in-mold pressure sensor value that is used for the injection molding.

3. The injection molding condition generation device according to claim 2, wherein
the characteristic value calculation unit calculates, as the characteristic value, an integral value of the in-mold pressure sensor value in an injection process, on a basis of time-series data of the in-mold pressure sensor value that is used for the injection molding.

4. The injection molding condition generation device according to claim 1, comprising:
a material information database in which the injection molding condition, the characteristic value, and the viscosity are associated with each other for the material each, wherein
the first prediction formula generation unit refers to the material information database to generate the first prediction formula, and records the generated first prediction formula in the material information database, and
the second prediction formula generation unit refers to the material information database to generate the second prediction formula, and records the generated second prediction formula in the material information database.

5. The injection molding condition generation device according to claim 4, comprising:
a database update unit configured to update the material information database by using information acquired from an external database.

6. The injection molding condition generation device according to claim 1, wherein
the second prediction formula generation unit generates an Andrade equation as the second prediction formula.

7. The injection molding condition generation device according to claim 1, comprising:
a UI control unit configured to present to a user the injection molding condition that is generated by the injection molding condition generation unit and is suitable for the second material, wherein
the UI control unit proposes a change of the second material to the user in a case where the injection molding condition suitable for the second material is out of a range of a condition window.

8. The injection molding condition generation device according to any one of claim 1, wherein
the injection molding condition includes at least one of a temperature of the material or a parameter for controlling a temperature of the material.

9. The injection molding condition generation device according to any one of claim 1, wherein
the first material is a virgin material, and
the second material is a recycled material.

10. An injection molding condition generation method performed by an injection molding condition generation device for generating an injection molding condition suitable for a second material when a material used for injection molding is changed from a first material to the second material,
the injection molding condition generation method comprising:
a first prediction formula generation step of generating a first prediction formula representing a relationship between a viscosity and a characteristic value of the material for the material each;
a second prediction formula generation step of generating, for the material each, a second prediction formula representing a relationship between the characteristic value and the injection molding condition when the material is used;
a characteristic value calculation step of calculating the characteristic value corresponding to the first material; and
an injection molding condition generation step of calculating the viscosity corresponding to the first material on a basis of the characteristic value corresponding to the first material and the first prediction formula corresponding to the first material, calculating the characteristic value corresponding to the second material on a basis of the viscosity corresponding to the first material and the first prediction formula corresponding to the second material, and generating the injection molding condition suitable for the second material on a basis of the characteristic value corresponding to the second material and the second prediction formula corresponding to the second material.

11. An injection molding system comprising:
an injection molding machine; and
an injection molding condition generation device for generating an injection molding condition suitable for a second material when a material used for injection molding is changed from a first material to the second material, wherein
the injection molding machine
outputs an in-mold sensor value to the injection molding condition generation device, and
the injection molding condition generation device includes:
a characteristic value calculation unit configured to calculate a characteristic value corresponding to the material, on a basis of the in-mold sensor value in the injection molding;
a first prediction formula generation unit configured to generate, for the material each, a first prediction formula representing a relationship between a viscosity and the characteristic value of the material;
a second prediction formula generation unit configured to generate, for the material each, a second prediction formula representing a relationship between the characteristic value and the injection molding condition when the material is used; and
an injection molding condition generation unit configured to calculate the viscosity corresponding to the first material on a basis of the characteristic value corresponding to the first material and the first prediction formula corresponding to the first material, calculate the characteristic value corresponding to the second material on a basis of the viscosity corresponding to the first material and the first prediction formula corresponding to the second material, and generate the injection molding condition suitable for the second material on a basis of the characteristic value corresponding to the second material and the second prediction formula corresponding to the second material.
